(19) United States
(12) Patent Application Publication
(10) Pub. No.: US 2026/0360833 A1
(43) Pub. Date: Nov. 12, 2026

(54) ELECTROMOBILITY COMPONENTS

(71) Applicant: LANXESS Deutschland GmbH, Cologne (DE)

(72) Inventors: Lars May, Langenfeld (DE); Marvin Kischkewitz, Duesseldorf (DE)

(73) Assignee: LANXESS Deutschland GmbH, Cologne (DE)

(21) Appl. No.: 19/515,130

(22) PCT Filed: Aug. 1, 2024
(86) PCT No.: PCT/EP2024/071808

§ 371 Date: Feb. 27, 2026

(30) Foreign Application Priority Data
Sep. 5, 2023 (EP) 23195344.9

(51) Int. Cl. H01M 10/42; C08K 5/56; H01M 8/02

(52) U.S. Cl. CPC H01M 10/42; C08K 5/56; H01M 8/02

(57) ABSTRACT

The present invention relates to tracking-resistant electromobility components having a colour distance ΔE from the L*a*b* coordinates to a colour number of the RAL colour chart beginning with a “2” of <20 containing polymer compositions based on at least one polyester and 1,3-dihydro-5,6-bis(((2-hydroxy-1-naphthyl)methylene)amino-2H-benzimidazol-2-onato(2-)-N5,N6,O5,O6)nickel and to the use of 1,3-dihydro-5,6-bis(((2-hydroxy-1-naphthyl)methylene)amino-2H-benzimidazol-2-onato(2-)-N5,N6,O5,O6)nickel for producing polyester-based tracking-resistant electromobility components having a colour distance ΔE from the L*a*b* coordinates to a colour number of the RAL colour chart beginning with a “2” of <20.

The present invention relates to tracking-resistant electromobility components having a colour distance ΔE from the L*a*b* coordinates to a colour number of the RAL colour chart beginning with a “2” of <20 containing polymer compositions based on at least one polyester and 1,3-dihydro-5,6-bis(((2-hydroxy-1-naphthyl)methylene)amino-2H-benzimidazol-2-onato(2-)-N5,N6,O5,O6)nickel and to the use of 1,3-dihydro-5,6-bis(((2-hydroxy-1-naphthyl)methylene)amino-2H-benzimidazol-2-onato(2-)—N5,N6,O5,O6)nickel for producing polyester-based tracking-resistant electromobility components having a colour distance ΔE from the L*a*b* coordinates to a colour number of the RAL colour chart beginning with a “2” of <20.

### PRIOR ART

Technical thermoplastics such as polyesters are important materials, especially also in the field of components for motor vehicles, due to their good mechanical stability, their chemicals resistance, very good electrical properties and good workability. They have therefore also formed an important constituent for manufacturing demanding motor vehicle components for many years. While the internal combustion engine has been the dominant drive concept for many years, new demands with regard to choice of materials are also arising in the course of the search for alternative drive concepts. A significant role is played here by electromobility, where the internal combustion engine has been replaced partly (hybrid vehicle [HEV, PHEV, BEV Rex]) or completely (electromobile [BEV, FCEV]) by one or more electric motors which typically draw their electrical energy from batteries or fuel cells. While conventional vehicles having an internal combustion engine (ICE) as their sole means of propulsion typically make do with a 12 V onboard voltage system, hybrid and electric vehicles having electric motors as drive unit require significantly higher voltages. This poses a serious additional risk potential for the direct region and the immediate surroundings of such high-voltage components, which plays an increasingly important role in technical specifications or else in standards. An important role is played here by the unambiguous marking of such dangerous regions in order thus to avoid unintentional contact with people, especially a driver, mechanic etc., with unambiguous colour marking of such electromobility components in turn being particularly important. At https://avt.inl.gov/sites/default/files/pdf/hev/hevtechspecr1.pdf, the Advanced Vehicle Team of the Idaho National Laboratory for HEV (Hybrid Electric Vehicles) has published a technical specification which calls for clear colour marking with the colour orange for all apparatuses subject to a high voltage of not less than 60 V. Such components to be marked in orange for electric drive of vehicles, in particular of motor vehicles, based on battery or fuel cell technology and components and systems to be used for electric drive units are electromobility components in the context of the present invention. However, as electrical components, voltage-conducting components or components subject to electrical voltage the tracking resistance is also an essential criterion for such electromobility components.

The tracking resistance defines the insulation strength of the surface (tracking path) of insulators, in particular under the influence of moisture and contaminants. It defines the maximum tracking current that may occur under standardized test conditions (predetermined voltage, thin-layer material) in a defined test configuration (electrode distance, electrode shape). A surface may be contaminated by abrasion or dust for example. In the case of polymer-based components, ingredients can diffuse to the surface and “contaminate” said surface. At sufficiently high atmospheric humidity this can form a conductive coating, through which a so-called tracking current flows. Some materials react quite sensitively to this energy input and are gradually destroyed by the electrochemical stress. The resulting carbon-containing decomposition products, in turn, cause the path taken by the tracking current to grow, in some cases with treeing, until electrical breakdown occurs.

The CTI value (comparative tracking index) in volts is a measure of the tendency to form a conductive path, especially in the case of contamination and moisture. Typical CTI values of selected materials are phenolic resin: 125 V; polyimide, Kapton: 150 V; PE-LD, PE-HD (polyethylene): 600 V; polyester resin: 600 V; PTFE (polytetrafluorethylene): 600 V. The CTI value is standardized only for voltages up to 600 V. For higher voltages it is also possible to test high-voltage tracking resistance (IPT or inclined plane tracking value). The CTI value indicates the voltage up to which the material surface is nonconductive. The standard EN50124 establishes a relationship between insulator groups and the CTI value: Insulator group I=CTI>600V; Insulation group II=400V<CTI<600V; Insulation group IIIa=175V<CTI<400V; Insulation group IIIb=100V<CTI<175 V.

The CTI value to be determined for the tracking resistance in the context of the present invention defines the voltage up to which the base material shows no tracking when 50 droplets of standardized electrolyte solutions (A or B, accordingly KA or KB value) are applied dropwise. Measurement is carried out at the surface, a droplet falling between two platinum electrodes every 30 seconds. The failure criterion is a tracking current of >0.5 A. Details of the method of measurement of the CTI value are specified in IEC 60112.

Electromobility components are known to the person skilled in the art from EP 3 947 020 B1, wherein these, designated (172), may include for example junction boxes, control units and/or wiring. According to the invention electromobility components include not only such components in direct contact with voltage-conducting parts but also those that directly adjacent thereto or in spatial proximity thereto act as a touch guard, a warning marking or a shielding means, wherein components in direct contact with the voltage-conducting parts are preferred according to the invention. In respect of battery components, electromobility components are, according to the invention, preferably standard and round cell modules, cell housings, cell connectors, cell contacting systems, module connectors, pressure compensating elements, seals and intelligent battery management systems. In respect of proton-exchange membrane fuel cells (PEMFC), electromobility components are preferably modules or stack modules, metallic bipolar plates, end and media modules and sealing systems. In an electric drive unit (EDU), electromobility components may be seals and other components, in particular function-integrated housing lids, housing seals, shaft sealing rings, disk carriers and stamped stacks. However, electromobility components in the context of the present invention finally also include shielding systems and dynamic precision parts.

CN 109 054 312 A describes polybutylene terephthalate fibres coloured with Pigment Orange 68.

WO 2014/175 450 A1 describes the provision of a black colourant for electric/electronic components having a high tracking resistance based on polybutylene terephthalate. The colourant is based either on a blue organic pigment a, a yellow organic pigment b and a red organic pigment c, or on at least a combination of blue organic pigment d and an orange-coloured pigment with the proviso that none of the organic pigments a to d contains a halogen atom in the molecular structure. Orange pigments recited in WO 2014/175 450 A1 include Pigment Orange 43, Pigment Orange 68 and Pigment Orange 73.

EP 3 792 303 A1 relates to polyester or polycarbonate compositions having a RAL number in the 2000s. In addition to tracking resistance it is also an object of EP 3 792 303 A1 to ensure amenability to laser marking and this is achieved with Pigment Orange 78, a cerium(III) sulfide/lanthanum(III) sulfide. As an optional additional component E) Pigment Orange 68 may be employed together with Pigment Orange 78.

JP H11 256050 A and JP H11 246775 A disclose polycarbonate compositions for electrical/electronic devices (not electromobility components) which may be coloured inter alia with Pigment Orange 68.

However, due to high processing temperatures of in some cases >300 °C during compounding and during injection moulding, the choice of suitable colourants for the orange marking of electromobility components is very limited especially for technical thermoplastics such as polyesters. Thus under extreme demands, especially under the demands in electromobility, dyes have a tendency to migrate out of the plastic matrix (blooming), which at elevated temperatures results in a reduction in colour intensity, or dyes migrate into other materials, for example adjacent plastics or plastic parts, which is known as bleeding. Such a dye migrating due to mechanical or physical processes can lead to adverse functional impairments. An example of this is a tracking current which can result from deposition of migrated dye onto the surface of electrical contacts. In electrical engineering a tracking current is to be understood as meaning an uncontrollable and undesired current which flows between two insulators along the surface of an insulator. The shortest path taken by this tracking current on the insulator surface is referred to as the tracking path. These fault currents on the insulator surface result in changes in the insulator over time. In the field of electrical components, migration of ingredients out of plastics is therefore generally unwanted since it can affect the properties of the plastics and of spatially adjacent parts, with the result that the function of the electrical component is no longer assured in some cases.

Thus, starting from the teaching of EP 3 947 020 B1 it is accordingly an object of the present invention to provide tracking-resistant electromobility components based on polyesters which are both unambiguously marked and recognizable via the colour orange but simultaneously undergo no significant reduction in the CTI determinable according to IEC 60112 as a measure of tracking resistance as a result of this colour marking.

It has surprisingly now been found that electromobility components based on at least one polyester and 1,3-dihydro-5,6-bis(((2-hydroxy-1-naphthyl)methylene)amino-2H-benzimidazol-2-onato(2-)—N5,N6,O5,O6)nickel meet the requirements specified when the colour orange is defined by a colour distance ΔE from the L*a*b* coordinates to a colour number of the RAL colour chart beginning with a “2” of <20 and the use of the colourant 1,3-dihydro-5,6-bis(((2-hydroxy-1-naphthyl)methylene)amino-2H-benzimidazol-2-onato(2-)—N5,N6,O5,O6)nickel ensures that the tracking resistance exhibits a maximum divergence in the CTI of 2.5% relative to a component of the same composition but without colourant, in particular without 1,3-dihydro-5,6-bis(((2-hydroxy-1-naphthyl)methylene)amino-2H-benzimidazol-2-onato(2-)—N5,N6,O5,O6)nickel.

### SUBJECT MATTER OF THE INVENTION

The invention provides tracking-resistant electromobility components having a colour distance ΔE from the L*a*b* coordinates to a colour number of the RAL colour chart beginning with a “2” of <20 based on at least one polyester and 1,3-dihydro-5,6-bis(((2-hydroxy-1-naphthyl)methylene)amino-2H-benzimidazol-2-onato(2-)—N5,N6,O5,O6)nickel having a CTI determinable according to IEC 60112 in the range from 425 to 600 volts and a maximum divergence in the CTI of 2.5% relative to a component of the same composition without colourant with the proviso that 0.01 to 3 parts by mass of 1,3-dihydro-5,6-bis(((2-hydroxy-1-naphthyl)methylene)amino-2H-benzimidazol-2-onato(2-)—N5,N6,O5,O6)nickel are employed per 100 parts by mass of polyester.

The invention preferably relates to tracking-resistant electromobility components for the process according to the invention having a colour distance ΔE from the L*a*b* coordinates to a colour number of the RAL colour chart beginning with a “2” of <10, particularly preferably <5.

Preference is given to tracking-resistant electromobility components wherein 0.01 to 2.5 parts by mass of 1,3-dihydro-5,6-bis(((2-hydroxy-1-naphthyl)methylene)amino-2H-benzimidazol-2-onato(2-)—N5,N6,O5,O6)nickel are present per 100 parts by mass of polyester.

The invention further relates to the use of 1,3-dihydro-5,6-bis(((2-hydroxy-1-naphthyl)methylene)amino-2H-benzimidazol-2-onato(2-)—N5,N6,O5,O6)nickel to obtain tracking-resistant polyester-based electromobility components having a colour distance ΔE from the L*a*b* coordinates to a colour number of the RAL colour chart beginning with a “2” of <20, preferably <10, in particular <5, wherein the tracking resistance in the form of a CTI determinable according to IEC 60112 is in the range from 425 to 600 volts with a maximum divergence in the CTI of 2.5% relative to a component of the same composition without colourant with the proviso that 0.01 to 3 parts by mass of 1,3-dihydro-5,6-bis(((2-hydroxy-1-naphthyl)methylene)amino-2H-benzimidazol-2-onato(2-)—N5,N6,O5,O6)nickel are employed per 100 parts by mass of polyester.

In the use according to the invention it is preferable when 0.01 to 2.5 parts by mass of 1,3-dihydro-5,6-bis(((2-hydroxy-1-naphthyl)methylene)amino-2H-benzimidazol-2-onato(2-)—N5,N6,O5,O6)nickel are present per 100 parts by mass of polyester.

Preparation of polymer compositions for producing electromobility components according to the invention is carried out by compounding and subsequent processing by injection moulding, by extrusion or by blow moulding by mixing the polyester to be employed as starting material with 1,3-dihydro-5,6-bis(((2-hydroxy-1-naphthyl)methylene)amino-2H-benzimidazol-2-onato(2-)—N5,N6,O5,O6)nickel, preferably in the aforementioned ratio, in at least one mixing apparatus. This affords moulding materials that either consist exclusively of these two components or else also contain at least one further component in addition to these two components.

For the sake of clarity, it is noted that the scope of the present invention comprises all of the definitions and parameters recited below in general or specified in preferred ranges in any desired combinations. This likewise relates to the combination of the stated amounts for the individual components in relation to the processes and uses claimed. The standards cited in the context of this application relate to the edition current at the filing date of the present invention. Unless otherwise stated, reported percentages are percentages by weight.

Tracking-resistant electromobility components according to the invention for electromobility are coloured orange using 1,3-dihydro-5,6-bis(((2-hydroxy-1-naphthyl)methylene)amino-2H-benzimidazol-2-onato(2-)—N5,N6,O5,O6)nickel, wherein hues corresponding in the RAL colour system to the colour numbers RAL2001, RAL2003, RAL2004, RAL2007, RAL2008, RAL2009, RAL2010 and RAL2011 are particularly preferred and the hues corresponding in the RAL colour system to the colour numbers RAL2003, RAL2008, RAL2010 and RAL2011 are very particularly preferred.

“Similar hues” permissible according to the invention and comprised by the present invention are those whose colour distance in the L*a*b* system to a colour number of the RAL colour chart beginning with a “2” has a ΔE of <20, preferably <10, particularly preferably <5. For elucidation of ΔE defined in EN ISO 11664-4 see, for example: https://de.wikipedia.org/wiki/Delta_E.

### Orange

In the context of the present invention, orange is considered to mean a colour which, in the RAL colour system according to https://de.wikipedia.org/wiki/RAL-Farbe#Orange, has a colour number beginning with a “2” in the RAL colour chart. In particular, at the filing date of the present invention, a distinction is made between orange hues according to Tab.1:

TABLE 1

| | | L* | a* | b* |
|---|---|---|---|---|
| RAL 2000 | Yellow orange | 58.20 | 37.30 | 68.68 |
| RAL 2001 | Red orange | 49.41 | 39.79 | 35.29 |
| RAL 2002 | Blood orange | 47.74 | 47.87 | 33.73 |
| RAL 2003 | Pastel orange | 66.02 | 41.22 | 52.36 |
| RAL 2004 | Pure orange | 56.89 | 50.34 | 49.81 |
| RAL 2005 | Luminous orange | 72.27 | 87.78 | 82.31 |
| RAL 2007 | Luminous bright orange | 76.86 | 47.87 | 97.63 |
| RAL 2008 | Bright red orange | 60.33 | 46.91 | 60.52 |
| RAL 2009 | Traffic orange | 55.83 | 47.79 | 48.83 |
| RAL 2010 | Signal orange | 55.39 | 40.10 | 42.42 |
| RAL 2011 | Deep orange | 59.24 | 40.86 | 64.50 |
| RAL 2012 | Salmon orange | 57.75 | 40.28 | 30.66 |
| RAL 2013 | Pearl orange | 40.73 | 32.14 | 34.92 |

Tab.1 shows the apparatus-independent CIE L*a*b* colour values for the respective RAL value: L* stands for luminance, a* describes the colour locus with respect to the red-green axis and b* describes the colour locus with respect to the yellow-blue axis using D65 standard light with a 10° field of view of a standard observer. The colour model is standardized in EN ISO 11664-4 “Colorimetry—Part 4: CIE 1976 L*a*b* Colour space”. For L*a*b* colour space (also: CIELAB), see: https://de.wikipedia.org/wiki/Lab-Farbraum. Each colour in the colour space is defined by a colour locus having the Cartesian coordinates {L*, a*, b*}. The a*b* coordinate plane was constructed using opponent colour theory. Green and red are at opposite ends of the a* axis from one another and the b* axis runs from blue to yellow. Complementary hues are respectively opposite one another at a 180° angle; all achromatic colours are arranged in the middle thereof (the coordinate origin a*=0, b*=0).

The L* axis describes the brightness (luminance) of the colour with values of 0 to 100. In the diagram it stands perpendicular to the a*b* plane at the origin. It may also be referred to as the neutral grey axis since all achromatic colours (grey hues) are contained between the endpoints of black (L*=0) and white (L*=100). The a* axis describes the green or red fraction of a colour, with negative values representing green and positive values representing red. The b* axis describes the blue or yellow fraction of a colour, with negative values representing blue and positive values representing yellow. The a* values range from approximately −170 to +100 and the b* values from −100 to +150, with the maximum values being achieved only at moderate brightness of certain hues. The CIELAB colour solid has its greatest extent in the region of moderate brightness, although this differs in height and size depending on the colour range.

### FURTHER PREFERRED EMBODIMENTS OF THE INVENTION

In a preferred embodiment the invention relates to tracking-resistant electromobility components having a colour distance ΔE from the L*a*b* coordinates to a colour number of the RAL colour chart beginning with a “2” of <20 which contain not only the at least one polyester and 1,3-dihydro-5,6-bis(((2-hydroxy-1-naphthyl)methylene)amino-2H-benzimidazol-2-onato(2-)—N5,N6,O5,O6)nickel but also at least one filler and/or reinforcer, preferably in an amount of 1 to 150 parts by mass, particularly preferably in an amount of 5 to 80 parts by mass, very particularly preferably in an amount of 10 to 50 parts by mass, in each case based on 100 parts by mass of polyester.

In a further preferred embodiment the invention relates to tracking-resistant electromobility components having a colour distance ΔE from the L*a*b* coordinates to a colour number of the RAL colour chart beginning with a “2” of <20 which contain not only the at least one polyester and 1,3-dihydro-5,6-bis(((2-hydroxy-1-naphthyl)methylene)amino-2H-benzimidazol-2-onato(2-)—N5,N6,O5,O6)nickel but also at least one flame retardant, preferably in an amount of 3 to 100 parts by mass, particularly preferably in an amount of 5 to 80 parts by mass, very particularly preferably in an amount of 10 to 50 parts by mass, in each case based on 100 parts by mass of polyester.

In a further preferred embodiment the invention relates to tracking-resistant electromobility components having a colour distance ΔE from the L*a*b* coordinates to a colour number of the RAL colour chart beginning with a “2” of <20 which contain not only the at least one polyester and 1,3-dihydro-5,6-bis(((2-hydroxy-1-naphthyl)methylene)amino-2H-benzimidazol-2-onato(2-)—N5,N6,O5,O6)nickel but also at least one additive, preferably in an amount of 0.01 to 80 parts by mass, particularly preferably in an amount of 0.05 to 50 parts by mass, very particularly preferably in an amount of 0.1 to 30 parts by mass, in each case based on 100 parts by mass of polyester.

C₂-C₁₀ Polyalkylene Terephthalates as the Polyester

C₂-C₁₀ polyalkylene terephthalates preferably employable according to the invention as the polyester in the context of the present invention are reaction products of an alcohol part having 2 to 10 carbon atoms in the alcohol part and terephthalic acid. C₂-C₁₀ polyalkylene terephthalates are known to those skilled in the art and extensively described in the literature. They contain an aromatic ring in the main chain which derives from the terephthalic acid and an aliphatic moiety which derives from a dihydroxy compound. The aromatic ring of the terephthalic acid may also be substituted. Preferred substituents are halogens or C₁-C₄ alkyl groups. Preferred halogens are chlorine or bromine. Preferred C₁-C₄ alkyl groups are methyl-, ethyl-, n-propyl- or n-, i- or t-butyl groups.

Preferably employable C₂-C₁₀ polyalkylene terephthalates are obtainable by reaction of aromatic dicarboxylic acids, their esters or other ester-forming derivatives with aliphatic dihydroxy compounds in a manner known to those skilled in the art.

In the case of the C₂-C₁₀ polyalkylene terephthalates, a portion up to 30 mol % of the terephthalic acid to be used for the production thereof may be replaced by 2,6-naphthalenedicarboxylic acid or isophthalic acid or mixtures thereof. Up to 70 mol %, preferably not more than 10 mol %, of the terephthalic acid may be replaced by aliphatic or cycloaliphatic dicarboxylic acids such as adipic acid, azelaic acid, sebacic acid, dodecanedioic acids and cyclohexanedicarboxylic acids.

Among the aliphatic dihydroxy compounds, preference is given to diols having 2 to 6 carbon atoms, especially ethane-1,2-diol, propane-1,3-diol, butane-1,4-diol, hexane-1,6-diol, hexane-1,4-diol, cyclohexane-1,4-diol, cyclohexane-1,4-dimethanol and neopentyl glycol or mixtures thereof. Particularly preferred polyalkylene terephthalates derive from alkanediols having 2 to 4 carbon atoms. Among these, preference is given especially to polyethylene terephthalate (PET), polypropylene terephthalate and polybutylene terephthalate (PBT) or mixtures thereof. Also preferred are PET and/or PBT which contain up to 1% by weight, preferably up to 0.75% by weight, of hexane-1,6-diol and/or 2-methylpentane-1,5-diol as further monomer units.

It is preferable when C₂-C₁₀ polyalkylene terephthalates employable as the polyester according to the invention have a viscosity number determinable according to ISO 1628 in the range from 50 to 220, preferably in the range from 80 to 160, by measurement in a 0.5% by weight solution in a 1:1 by weight phenol/o-dichlorobenzene mixture at 25 °C.

C₂-C₁₀ polyalkylene terephthalates preferably employable as the polyester according to the invention preferably have a carboxyl end group content of up to 100 meq/kg polyester, particularly preferably of up to 50 meq/kg polyester and especially preferably of up to 40 meq/kg polyester. Such C₂-C₁₀ polyalkylene terephthalates may be produced for example by the process according to DE-A 44 01 055. The carboxyl end group content is typically determined by titration processes, especially potentiometry.

Especially preferred C₂-C₁₀ polyalkylene terephthalates employable as the polyester are produced with Ti catalysts. After polymerization these preferably have a residual Ti content of 5250 ppm, more preferably of <200 ppm, most preferably of <150 ppm.

The polybutylene terephthalate (PBT) [CAS No. 24968-12-5] preferably employable as the polyester according to the invention is produced from terephthalic acid or the reactive derivatives thereof and butanediol by known methods (Kunststoff-Handbuch, Vol. Vill, pp. 695-743, Karl Hanser Verlag, Munich 1973).

The PBT employable as the polyester preferably contains at least 80 mol %, preferably at least 90 mol %, based on the dicarboxylic acid, of terephthalic acid radicals.

In one embodiment, PBT preferably employable as the polyester according to the invention may contain not only terephthalic acid radicals but also up to 20 mol % of radicals of other aromatic dicarboxylic acids having 8 to 14 carbon atoms or radicals of aliphatic dicarboxylic acids having 4 to 12 carbon atoms, especially radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid, cyclohexanedicarboxylic acid and 2,5-furandicarboxylic acid.

In one embodiment, PBT preferably employable as the polyester according to the invention may contain not only butanediol but also up to 20 mol % of other aliphatic diols having 3 to 12 carbon atoms or up to 20 mol % of cycloaliphatic diols having 6 to 21 carbon atoms, preferably radicals of propane-1,3-diol, 2-ethylpropane-1,3-diol, neopentyl glycol, pentane-1,5-diol, hexane-1,6-diol, 1,4-cyclohexanedimethanol, 3-methylpentane-2,4-diol, 2-methylpentane-2,4-diol, 2,2,4-trimethylpentane-1,3-diol, 2,2,4-trimethylpentane-1,5-diol, 2-ethylhexane-1,3-diol, 2,2-diethylpropane-1,3-diol, hexane-2,5-diol, 1,4-di(p-hydroxyethoxy)benzene, 2,2-bis(4-hydroxycyclohexyl)propane, 2,4-dihydroxy-1,1,3,3-tetramethylcyclobutane, 2,2-bis(3-R-hydroxyethoxyphenyl)propane and 2,2-bis(4-hydroxypropoxyphenyl)propane.

PBT preferably employable as the polyester has an intrinsic viscosity according to EN-ISO 1628/5 in the range from 40 to 170 cm³/g, particularly preferably in the range from 50 to 150 cm³/g, very particularly preferably in the range from 65 to 135 cm³/g, in each case measured in phenol/o-dichlorobenzene (1:1 parts by weight) at 25 °C in an Ubbelohde viscometer. The intrinsic viscosity IV, also referred to as Staudinger Index or limiting viscosity, is proportional, according to the Mark-Houwink equation, to the average molecular mass, and is the extrapolation of the viscosity number VN for the case of vanishing polymer concentrations. It can be estimated from series of measurements or through the use of suitable approximation methods (e.g. Billmeyer). The VN [ml/g] is obtained from the measurement of the solution viscosity in a capillary viscometer, for example an Ubbelohde viscometer. Solution viscosity is a measure of the average molecular weight of a plastic. The determination is effected on dissolved polymer, with various solvents (m-cresol, tetrachloroethane, phenol, 1,2-dichlorobenzene, etc.) and concentrations being used. The viscosity number VN makes it possible to monitor the processing and performance characteristics of plastics. Thermal stress on the polymer, ageing processes or exposure to chemicals, weathering and light can be investigated by means of comparative measurements. In this regard, see also: http://de.wikipedia.org/wiki/Viskosimetrie and http://de.wikipedia.org/wiki/Mark-Houwink-Gleichung.

PBT preferably employable as the polyester may also be used in admixture with other polymers. The production of PBT blends employable according to the invention is effected by compounding. During such a compounding operation, customary additives, especially demoulding agents or elastomers, may additionally be added to the melt to improve the properties of the blends.

PBT preferably employable according to the invention is available from Lanxess Deutschland GmbH, Cologne under the name Pocan® B 1300.

### Polycarbonate as the Polyester

Also preferably employable as the polyester according to the invention is at least one thermoplastic from the group of polycarbonates.

Polycarbonates preferably employable according to the invention are homopolycarbonates or copolycarbonates based on bisphenols of general formula (I),

HO—Z—OH (I)

in which Z is a divalent organic radical which has 6 to 30 carbon atoms and contains one or more aromatic groups.

The polyester employed is preferably at least one polycarbonate based on bisphenols of formula (Ia)

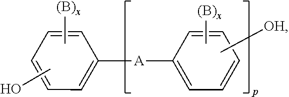

wherein
A is a single bond or a radical from the group of C₁-C₅ alkylene, C₂-C₅ alkylidene, C₅-C₆ cycloalkylidene, —O—, —SO—, —CO—, —S—, —SO₂—, C₆-C₁₂ arylene, onto which further aromatic, optionally heteroatom-containing, rings may be condensed,
   or A is a radical of formula (II) or (III)

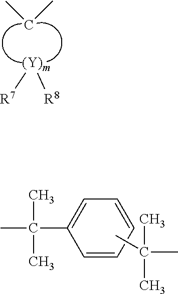

wherein
R⁷ and R⁸ are individually selectable for each Y and independently of one another are hydrogen or C₁-C₆ alkyl, preferably hydrogen, methyl or ethyl,
B in each case is C₁-C₁₂ alkyl, preferably methyl, halogen, preferably chlorine and/or bromine,
x is independently at each occurrence 0, 1 or 2,
p is 1 or 0,
Y is carbon, and
m is an integer from 4 to 7, preferably 4 or 5, with the proviso that on at least one Y (carbon
atom), R⁷ and R⁸ are simultaneously alkyl.

In a preferred embodiment:
when m is 4, Y is —CR⁷R⁸—CR⁷R⁸—CR⁷R⁸—CR⁷R⁸—;
when m is 5, Y is —CR⁷R⁸—CR⁷R⁸—CR⁷R⁸—CR⁷R⁸—CR⁷R⁸—;
when m is 6, Y is —CR⁷R⁸—CR⁷R⁸—CR⁷R⁸—CR⁷R⁸—CR⁷R⁸—CR⁷R⁸—; and
when m is 7, Y is —CR⁷R⁸—CR⁷R⁸—CR⁷R⁸—CR⁷R⁸—CR⁷R⁸—CR⁷R⁸—CR⁷R⁸—.

Preferred bisphenols containing the general formula (II) are bisphenols from the group of dihydroxydiphenyls, bis-(hydroxyphenyl)-alkanes, bis-(hydroxyphenyl)-cycloalkanes, indane bisphenols, bis-(hydroxyphenyl)-sulfides, bis-(hydroxyphenyl)-ethers, bis-(hydroxyphenyl)-ketones, bis-(hydroxyphenyl)-sulfones, bis-(hydroxyphenyl)-sulfoxides and α,α′-bis-(hydroxyphenyl)-diisopropylbenzoles.

Preferably employable bisphenols containing the general formula (II) also include derivatives of the recited bisphenols preferably obtainable by alkylation or halogenation at the aromatic rings of the recited bisphenols.

Particularly preferred bisphenols containing the general formula (11) are hydroquinone, resorcinol, 4,4′-dihydroxydiphenyl, bis(4-hydroxyphenyl) sulfide, bis(4-hydroxyphenyl) sulfone, bis(3,5-dimethyl-4-hydroxyphenyl)methane, bis(3,5-dimethyl-4-hydroxyphenyl) sulfone, 1,1-bis(3,5-dimethyl-4-hydroxyphenyl)-p/m-diisopropylbenzene, 1,1-bis(4-hydroxyphenyl)-1-phenylethane, 1,1-bis(3,5-dimethyl-4-hydroxyphenyl)cyclohexane, 1,1-bis(4-hydroxyphenyl)-3-methylcyclohexane, 1,1-bis(4-hydroxyphenyl)-3,3-dimethylcyclohexane, 1,1-bis(4-hydroxyphenyl)-4-methylcyclohexane, 1,1-bis(4-hydroxyphenyl)-cyclohexane, 1,1-bis(4-hydroxyphenyl)-3,3,5-trimethylcyclohexane, 2,2-bis(3,5-dichloro-4-hydroxyphenyl)propane, 2,2-bis(3-methyl-4-hydroxyphenyl)propane, 2,2-bis(3,5-dimethyl-4-hydroxyphenyl)propane, 2,2-bis(4-hydroxyphenyl)propane (i.e. bisphenol A), 2,2-bis(3-chloro-4-hydroxyphenyl)propane, 2,2-bis(3,5-dibromo-4-hydroxyphenyl)propane, 2,4-bis(4-hydroxyphenyl)-2-methylbutane, 2,4-bis(3,5-dimethyl-4-hydroxyphenyl)-2-methylbutane, bis(4-hydroxyphenyl)-o-diisopropylbenzene, α,α′-bis(4-hydroxyphenyl)-m-diisopropylbenzene (i.e. bisphenol M), α,α′-bis(4-hydroxyphenyl)-p-diisopropylbenzene and indane bisphenol.

The described bisphenols of the general formula (II) may be produced by processes known to those skilled in the art, preferably from the corresponding phenols and ketones.

The polycarbonates employable as the polyester may also be produced by known processes. Preferred processes for producing polycarbonates are for example the production from bisphenols with phosgene by the phase interface process, or from bisphenols with phosgene by the homogeneous phase process, the so-called pyridine process, or from bisphenols with carbonate esters by the melt transesterification process. The recited bisphenols and processes for their production are described for example in the monograph H. Schnell, “Chemistry and Physics of Polycarbonates”, Polymer Reviews, Volume 9, pp. 77-98, Interscience Publishers, New York, London, Sydney, 1964 and in U.S. Pat. No. 3,028,635, in U.S. Pat. No. 3,062,781, in U.S. Pat. No. 2,999,835, in U.S. Pat. No. 3,148,172, in U.S. Pat. No. 2,991,273, in U.S. Pat. No. 3,271,367, in US-A 4 982 014, in U.S. Pat. No. 2,999,846, in DE-A 1 570 703, in DE-A 2 063 050, in DE-A 2 036 052, in DE-A 2 211 956, in DE-A 3 832 396, and in FR-A 1 561 518 and also in the Japanese laid-open specifications having the application numbers JP-A 62039 1986, JP-A 62040 1986 and JP-A 105550 1986.

1,1-Bis(4-hydroxyphenyl)-3,3,5-trimethylcyclohexane and the production thereof is described, for example, in U.S. Pat. No. 4,982,014.

Indane bisphenols and the production thereof are described, for example, in U.S. Pat. No. 3,288,864, in JP-A 60 035 150 and in U.S. Pat. No. 4,334,106. Indane bisphenols may be produced, for example, from isopropenylphenol or derivatives thereof or from dimers of isopropenylphenol or derivatives thereof in the presence of a Friedel-Craft catalyst in organic solvents.

The melt transesterification process is described in H. Schnell, “Chemistry and Physics of Polycarbonates”, Polymer Reviews, Volume 9, pages 44 to 51, Interscience Publishers, New York, London, Sydney, 1964 and in DE-A 1 031 512.

In the production of polycarbonate, preference is given to using raw materials and auxiliaries having a low level of impurities. Especially in the case of production by the melt transesterification process, the bisphenols used and the carbonic acid derivatives used are ideally to be very substantially free of alkali metal ions and alkaline earth metal ions. Raw materials having such a degree of purity are obtainable for example by recrystallizing, washing or distilling the carbonic acid derivatives, in particular carbonate esters, and the bisphenols.

Polycarbonates preferably employable as the polyester according to the invention preferably have a weight-average molar mass Mw in the range from 10 000 to 200 000 g/mol determinable by ultracentrifugation (see K. Schilling, Analytische Ultrazentrifugation, Nanolytics GmbH, Dallgow, pages 1-15) or scattered light measurement according to DIN EN ISO 16014-5:2012-10. It is particularly preferable when the employable polycarbonates have a weight-average molar mass in the range from 12 000 to 80 000 g/mol, especially preferably a weight-average molar mass in the range from 20 000 to 35 000 g/mol.

The average molar mass of polycarbonates preferably employable as the polyester according to the invention may preferably be adjusted in known fashion using an appropriate amount of chain terminators. The chain terminators may be used individually or as a mixture of different chain terminators.

Preferred chain terminators include both monophenols and monocarboxylic acids. Preferred monophenols are phenol, p-chlorophenol, p-tert-butylphenol, cumylphenol or 2,4,6-tribromophenol, and also long-chain alkylphenols, especially 4-(1,1,3,3-tetramethylbutyl)phenol or monoalkylphenols/dialkylphenols having a total of 8 to 20 carbon atoms in the alkyl substituents, especially 3,5-di-tert-butylphenol, p-tert-octylphenol, p-dodecylphenol, 2-(3,5-dimethylheptyl)phenol or 4-(3,5-dimethylheptyl)phenol. Preferred monocarboxylic acids are benzoic acid, alkylbenzoic acids or halobenzoic acids.

Particularly preferred chain terminators are phenol, p-tert-butylphenol, 4-(1,1,3,3-tetramethylbutyl)phenol or cumylphenol.

The amount of chain terminators to be employed is preferably in the range from 0.25 to 10 mol % based on the sum of the bisphenols employed in each case.

Polycarbonates preferably employable as the polyester according to the invention may be branched in known fashion, preferably by the incorporation of branching agents that are trifunctional or more than trifunctional. Preferred branching agents have three or more than three phenolic groups or three or more than three carboxylic acid groups.

Particularly preferred branching agents are phloroglucinol, 4,6-dimethyl-2,4,6-tri-(4-hydroxyphenyl)hept-2-ene, 4,6-dimethyl-2,4,6-tri-(4-hydroxyphenyl)heptane, 1,3,5-tri-(4-hydroxyphenyl)benzene, 1,1,1-tris-(4-hydroxyphenyl)ethane, tri(4-hydroxyphenyl)phenylmethane, 2,2-bis[4,4-bis(4-hydroxyphenyl)cyclohexyl]propane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, hexa(4-(4-hydroxyphenylisopropyl)phenyl) terephthalate, tetra(4-hydroxyphenyl)methane, tetra(4-(4-hydroxyphenylisopropyl)phenoxy)methane and 1,4-bis(4′,4″-dihydroxytriphenyl)methylbenzene, 2,4-dihydroxybenzoic acid, trimesic acid, cyanuric chloride, 3,3-bis(3-methyl-4-hydroxyphenyl)-2-oxo-2,3-dihydroindole, trimesyl trichloride or α,α′,α″-tris-(4-hydroxyphenol)-1,3,5-triisopropylbenzene.

Very particularly preferred branching agents are 1,1,1-tris-(4-hydroxyphenyl)-ethane or 3,3-bis-(3-methyl-4-hydroxyphenyl)-2-oxo-2,3-dihydroindole.

The amount of branching agents to be employed is preferably in the range from 0.05 mol % to 2 mol % based on the moles of bisphenols employed.

When a polycarbonate is produced by the phase interface process, the branching agents are preferably included in an initially charged aqueous alkaline phase with the bisphenols and the chain terminators or added together with the carbonic acid derivatives as a solution in an organic solvent. If the transesterification process is used, the branching agents are preferably metered in together with the dihydroxyaromatics or bisphenols.

Catalysts preferably employed in the production of polycarbonates preferably employable as the polyester according to the invention by the melt transesterification process are ammonium salts and phosphonium salts, as described, for example, in U.S. Pat. No. 3,442,864, JP-A-14742/72, U.S. Pat. No. 5,399,659 or DE-A 19 539 290.

In a preferred embodiment, it is also possible to employ copolycarbonates as the polyester. In the context of the present invention, copolycarbonates are especially polydiorganosiloxane-polycarbonate block copolymers having a weight-average molar mass Mw preferably in the range from 10 000 to 200 000 g/mol, particularly preferably in the range from 20 000 to 80 000 g/mol, determined by gel chromatography according to DIN EN ISO 16014-5:2012-10 after prior calibration by scattered light measurement or ultracentrifugation. The content of aromatic carbonate structural units in the polydiorganosiloxane-polycarbonate block copolymers is preferably in the range from 75% to 97.5% by weight, particularly preferably in the range from 85% to 97% by weight. The content of polydiorganosiloxane structural units in the polydiorganosiloxane-polycarbonate block copolymers is preferably in the range from 25% to 2.5% by weight, particularly preferably in the range from 15% to 3% by weight. The polydiorganosiloxane-polycarbonate block copolymers are preferably producible from polydiorganosiloxanes containing α,ω-bishydroxyaryloxy end groups and having an average degree of polymerization Pₙ in the range from 5 to 100, particularly preferably having an average degree of polymerization Pₙ in the range from 20 to 80.

Polycarbonates particularly preferably employable as the polyester include the homopolycarbonate based on bisphenol A, the homopolycarbonate based on 1,1-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane (=bisphenol TMC). Polycarbonates preferably employable as the polyester according to the invention are obtainable for example from Covestro AG, Leverkusen under the Makrolon® brand.

In one embodiment, the polycarbonates employable as the polyester may have customary additives, especially demoulding agents, added thereto in the melt or applied to the surface.

The polycarbonates employable as the polyester preferably already contain demoulding agents before a subsequent compounding with the other components, wherein a person skilled in the art understands compounding to mean the plastics-industry term, synonymous with plastics processing, which describes the finishing process for plastics by admixture of additive substances (fillers, additives, etc.) for specific optimization of profiles of properties. See: https://de.wikipedia.org/wiki/Compoundierung. Compounding is preferably effected in extruders, particularly preferably in co-rotating twin-screw extruders, counter-rotating twin-screw extruders, planetary screw extruders or co-compounders, and comprises the process operations of conveying, melting, dispersing, mixing, degassing and pressure build-up.

However, in a preferred embodiment it is also possible to use blends of polycarbonate and polyalkylene terephthalates likewise marketed by Covestro AG under the Makroblend® brand as the polyester. These are preferably PC-PET blends, PC-PBT blends or PC-PCT-G blends, where PC stands for polycarbonate, PET for polyethylene terephthalate, PBT for polybutylene terephthalate and PCT for polycyclohexylene dimethylene terephthalate.

### 1,3-dihydro-5,6-bis(((2-hydroxy-1-naphthyl)methylene)amino-2H-benzimidazol-2-onato(2-)—N5,N6,O5,O6)nickel

According to the invention the orange pigment employed is the 1,3-dihydro-5,6-bis(((2-hydroxy-1-naphthyl)methylene)amino-2H-benzimidazol-2-onato(2-)—N5,N6,O5,O6)nickel known from DE OS 2263235. 1,3-dihydro-5,6-bis(((2-hydroxy-1-naphthyl)methylene)amino-2H-benzimidazol-2-onato(2-)—N5,N6,O5,O6)nickel may either be produced by one of the two processes in example 2 of DE OS 2263235 or is available as Pigment Orange 68 [CAS No. 42844-43-9] inter alia from Sinoever International, Dalian, China. For Pigment Orange 68 or 1,3-dihydro-5,6-bis(((2-hydroxy-1-naphthyl)methylene)amino-2H-benzimidazol-2-onato(2-)—N5,N6,O5,O6)nickel [CAS No. 42844-93-9] Sinoever International specifies the colour locus having the Cartesian coordinates L*=53.5 a*=58.2 and b*=76.7.

The 1,3-dihydro-5,6-bis(((2-hydroxy-1-naphthyl)methylene)amino-2H-benzimidazol-2-onato(2-)—N5,N6,O5,O6)nickel may be employed directly as a powder or else in the form of a masterbatch, in the form of a compact or in the form of a concentrate, wherein masterbatches are preferred and masterbatches in a polyester matrix are particularly preferred. 1,3-Dihydro-5,6-bis(((2-hydroxy-1-naphthyl)methylene)amino-2H-benzimidazol-2-onato(2-)—N5,N6,O5,O6)nickel may be described as an adduct. An adduct in the context of the present invention is an assembled molecule wherein the bond between the metal—here nickel—and the rest of the molecule is preferably effected through intermolecular interactions, through Lewis acid-based interactions or through coordinative bonds. The term “adduct” in the context of the present invention is intended generally to encompass all types of intercalation and addition compounds. The terms “intercalation compound” or “addition compound” in the context of the present invention are preferably compounds that are formed by virtue of intermolecular interactions such as van der Waals interactions or Lewis acid-base interactions. The manner in which the intercalation proceeds in this case depends not only on the chemical properties of the component to be intercalated but also on the chemical nature of the host lattice. Such compounds are often also referred to as intercalation compounds. In the chemical sense, this refers to the incorporation of molecules, ions—occasionally even atoms—into chemical compounds.

Furthermore, the terms “intercalation compound” or “addition compound” are to be understood as also encompassing so-called clathrates. These are compounds of two substances, one of which is a guest molecule intercalated into a lattice or cage composed of a host molecule.

The terms “intercalation compound” or “addition compound” in the context of the present invention are to be understood as also encompassing mixed intercalation crystals and interstitial compounds. These are chemical, non-stoichiometric, crystalline compounds formed of at least two elements.

In addition, the terms “intercalation compound” or “addition compound” in the context of the present invention shall also be understood as encompassing compounds which are formed on the basis of coordinate bonds or complex bonds. Such compounds are in some cases also referred to as mixed substitution crystals or mixed replacement crystals in which at least two substances form a common crystal and the atoms of the second component are located at regular lattice sites of the first component.

### Further Components

In a preferred embodiment at least one filler or reinforcer is employed. It is also possible to employ mixtures of two or more different fillers and/or reinforcers.

Preference is given to using at least one filler or reinforcer from the group of carbon fibres [CAS No. 7440-44-0], glass beads or solid or hollow glass beads, or glass fibres, or ground glass, amorphous quartz glass, aluminium borosilicate glass having an alkali content of 1% (E glass) [CAS No. 65997-17-3], amorphous silica [CAS No. 7631-86-9], quartz flour [CAS No. 14808-60-7], calcium silicate [CAS No. 1344-95-2], calcium metasilicate [CAS No. 10101-39-0], magnesium carbonate [CAS No. 546-93-0], kaolin [CAS No. 1332-58-7], calcined kaolin [CAS No. 92704-41-1], chalk [CAS No. 1317-65-3], kyanite [CAS No. 1302-76-7], powdered or milled quartz [CAS No. 14808-60-7], mica [CAS No. 1318-94-1], phlogopite [CAS No. 12251-00-2], barium sulfate [CAS No. 7727-43-7], feldspar [CAS No. 68476-25-5], wollastonite [CAS No. 13983-17-0], montmorillonite [CAS No. 67479-91-8], pseudoboehmite of formula AIO(OH), magnesium carbonate [CAS No. 12125-28-9] and talc [CAS No. 14807-96-6].

Particularly preferred fibrous fillers or reinforcers include glass fibres and wollastonite, wherein glass fibres are very particularly preferred. According to “http://de.wikipedia.org/wiki/Faser-Kunststoff-Verbund”, in terms of the glass fibres a person skilled in the art distinguishes between chopped fibres, also called short fibres, having a length in the range from 0.1 to 1 mm, long fibres having a length in the range from 1 to 50 mm, and continuous fibres having a length L>50 mm. Short fibres are preferably employed in injection moulding technology and may be directly processed with an extruder. Long fibres can likewise still be processed in extruders. Said fibres are widely used in fibre spraying. Long fibres are frequently added to thermosets as a filler. Continuous fibres are used in the form of rovings or weaves in fibre-reinforced plastics. Articles of manufacture comprising continuous fibres achieve the highest stiffness and strength values. Also available are ground glass fibres, the length of which after grinding is typically in the range from 70 to 200 μm.

Glass fibres preferably employable as fillers or reinforcers according to the invention include chopped long glass fibres having an average starting length determinable by laser diffraction particle size analysis (laser granulometry/laser diffractometry) according to ISO 13320 in the range from 1 to 50 mm, particularly preferably in the range from 1 to 10 mm, very particularly preferably in the range from 2 to 7 mm. For laser diffraction particle size determination/laser diffractometry according to the standard ISO 13320, see:
https://de.wikipedia.org/wiki/Laserbeugungs-Partikeigr%C3%B6%C3%9Fenanalyse

Preferred glass fibres employable as fillers or reinforcers have an average fibre diameter determinable by laser diffractometry according to ISO 13320 in the range from 7 to 18 μm, particularly preferably in the range from 9 to 15 μm.

In a preferred embodiment, the glass fibres preferably employable as fillers or reinforcers are preferably modified with a suitable size system or an adhesion promoter/adhesion promoter system. Preference is given to using a size system or a silane-based adhesion promoter.

### Flame Retardants

In a preferred embodiment at least one flame retardant is employed. Preferred flame retardants are mineral flame retardants, nitrogen-containing flame retardants or phosphorus-containing flame retardants.

Among the mineral flame retardants, magnesium hydroxide is particularly preferred. Magnesium hydroxide [CAS No. 1309-42-8] may be impure as a result of its origin and mode of production. Typical impurities include, for example, silicon-, iron-, calcium- and/or aluminum-containing species which may be intercalated, for example, in the form of oxides in the magnesium hydroxide crystals. The magnesium hydroxide employable as a mineral flame retardant may be unsized or else sized. The magnesium hydroxide employable as a mineral flame retardant is preferably provided with sizes based on stearates or aminosiloxanes, particularly preferably with aminosiloxanes. Magnesium hydroxide preferably employable as a mineral flame retardant has an average particle size d50 determinable by laser diffractometry according to ISO 13320 in the range from 0.5 μm to 6 μm, preference being given to a d50 in the range from 0.7 μm to 3.8 μm and particular preference being given to a d50 in the range from 1.0 μm to 2.6 μm.

Magnesium hydroxide types suitable as a mineral flame retardant according to the invention include for example Magnifin® H51V from Martinswerk GmbH, Bergheim, Germany or Hidromag® Q2015 TC from Penoles, Mexico City, Mexico.

Preferred nitrogen-containing flame retardants include the reaction products of trichlorotriazine, piperazine and morpholine of CAS No. 1078142-02-5, in particular MCA PPM Triazine HF from MCA Technologies GmbH, Biel-Benken, Switzerland, and also melamine cyanurate and condensation products of melamine, in particular melem, melam, melon or more highly condensed compounds of this type. Preferred inorganic nitrogen-containing compounds are ammonium salts.

In addition, it is also possible to use salts of aliphatic and aromatic sulfonic acids and mineral flame retardant additives, especially aluminum hydroxide or Ca—Mg carbonate hydrates (DE-A 4236 122).

However, in an alternative embodiment, zinc-containing compounds may also be employed. These preferably include zinc oxide, zinc borate, zinc stannate, zinc hydroxystannate, zinc sulfide and zinc nitride, or mixtures thereof.

Preferred phosphorus-containing flame retardants are organic metal phosphinates, aluminium salts of phosphonic acid, red phosphorus, inorganic metal hypophosphites, metal phosphonates, derivatives of 9,10-dihydro-9-oxa-10-phosphaphenanthrene-10-oxides (DOPO derivatives), resorcinol bis(diphenyl phosphate) (RDP) including oligomers, bisphenol A bis(diphenyl phosphate) (BDP) including oligomers, melamine pyrophosphate, melamine polyphosphate, melamine poly(aluminium phosphate), melamine poly(zinc phosphate) or phenoxyphosphazene oligomers and mixtures thereof.

A preferred organic metal phosphinate is aluminum tris(diethylphosphinate). A preferred inorganic metal hypophosphite is aluminum hypophosphite.

Further employable flame retardants include char formers, particularly preferably phenol-formaldehyde resins, polycarbonates, polyimides, polysulfones, polyether sulfones or polyether ketones, and also antidrip agents, in particular tetrafluoroethylene polymers.

Halogen-containing flame retardants may also be employed. Preferred halogen-containing flame retardants are commercially available organic halogen compounds, more preferably ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene or brominated polyphenylene ethers, which can be used alone or in combination with synergists, especially antimony trioxide or antimony pentoxide, wherein among the halogenated flame retardants brominated polystyrene is particularly preferred. Brominated polystyrene is used here preferably in amounts in the range from 10% to 30% by weight, particularly preferably in amounts in the range from 15% to 25% by weight, based in each case on the overall composition, where at least one of the other components is reduced to such an extent that the sum total of all weight percentages is always 100.

Brominated polystyrene is commercially available in a wide variety of product qualities. Examples thereof are for example Firemaster® PBS64 from Lanxess, Cologne, Germany and Saytex® HP-3010 from Albemarle, Baton Rouge, USA.

### Additives

In a preferred embodiment an additive is employed in addition to the polyester and 1,3-dihydro-5,6-bis(((2-hydroxy-1-naphthyl)methylene)amino-2H-benzimidazol-2-onato(2-)—N5,N6,O5,O6)nickel. Preferably employable additives include antioxidants, thermal stabilizers, UV stabilizers, gamma ray stabilizers, components for reducing water absorption or hydrolysis stabilizers, antistats, emulsifiers, nucleating agents, plasticizers, processing auxiliaries, impact modifiers, lubricants and/or demoulding agents, components for reducing water absorption, flow auxiliaries or elastomer modifiers, chain-extending additives and colourants distinct from 1,3-dihydro-5,6-bis(((2-hydroxy-1-naphthyl)methylene)amino-2H-benzimidazol-2-onato(2-)—N5,N6,O5,O6)nickel. The additives may be employed alone or in admixture or in the form of masterbatches.

Preferable heat stabilizers as additives include sterically hindered phenols, in particular those containing at least one 2,6-di-tert-butylphenyl- and/or 2-tert-butyl-6-methylphenyl group, and also phosphites, hypophosphites, especially sodium hypophosphite NaH₂PO₂, hydroquinones, aromatic secondary amines, substituted resorcinols, salicylates, benzotriazoles and benzophenones, 3,3′-thiodipropionic esters and variously substituted representatives of these groups or mixtures thereof. The heat stabilizers employable as additives are preferably employed in amounts of 0.01 to 2 parts by mass, particularly preferably 0.05 to 1 parts by mass, in each case based on 100 parts by mass of polyesters.

UV stabilizers employable as additives preferably include substituted resorcinols, salicylates, benzotriazoles and benzophenones, HALS derivatives (“Hindered Amine Light Stabilizers”) containing at least one 2,2,6,6-tetramethyl-4-piperidyl unit or benzophenones. The UV stabilizers employable as additives are preferably employed in amounts of 0.01 to 2 parts by mass, particularly preferably 0.1 to 1 parts by mass, in each case based on 100 parts by mass of polyesters.

Colourants employable as additives and distinct from 1,3-dihydro-5,6-bis(((2-hydroxy-1-naphthyl)methylene)amino-2H-benzimidazol-2-onato(2-)—N5,N6,O5,O6)nickel preferably include inorganic pigments, in particular ultramarine blue, bismuth vanadate, iron oxide, titanium dioxide, zinc sulfide, cerium sulfide, tin-titanium-zinc oxides [CAS No. 923954-49-8] and also organic dyes, preferably phthalocyanines, quinacridones, benzimidazoles, in particular pyrimidine-azo-benzimidazole [CAS No. 72102-84-2] and/or Pigment Yellow 192 [CAS No. 56279-27-7] as well as perylenes, anthraquinones, in particular C. Solvent Yellow 163 [CAS No. 13676-91-0] perinones, in particular 10,10′-Oxy-bis-12H-phthaloperin-12-one [CAS No. 203576-97-0], this enumeration being nonexhaustive. In one embodiment, carbon black or nigrosine are also employed as colourants.

Nucleating agents employable as additives preferably include sodium or calcium phenylphosphinate, aluminum oxide or silicon dioxide and very particularly preferably talc, this enumeration being nonexhaustive.

Plasticizers preferably employable as additives include dioctyl phthalate, dibenzyl phthalate, butyl benzyl phthalate, hydrocarbon oils or N-(n-butyl)benzenesulfonamide.

Elastomer modifiers preferably employable as additives comprise inter alia one or more graft polymers of
E.1 5% to 95% by weight, preferably 30% to 90% by weight, of at least one vinyl monomer and
E.2 95% to 5% by weight, preferably 70% to 10% by weight, of one or more graft substrates having glass transition temperatures <10 °C, preferably <0 °C, particularly preferably <−20 °C, where the percentages by weight are based on 100% by weight of elastomer modifier. The graft substrate E.2 generally has an average particle size d50 value determinable by laser diffractometry according to ISO 13320 of 0.05 to 10 μm, preferably 0.1 to 5 μm, particularly preferably 0.2 to 1 μm.

Monomers E.1 are preferably mixtures of
E.1.1 50% to 99% by weight of vinylaromatics and/or ring-substituted vinylaromatics, especially styrene, α-methylstyrene, p-methylstyrene, p-chlorostyrene, and/or (C₁-C₈)-alkyl methacrylates, especially methyl methacrylate, ethyl methacrylate and
E.1.2 1% to 50% by weight of vinyl cyanides, especially unsaturated nitriles such as acrylonitrile and methacrylonitrile and/or (C₁-C₈)-alkyl (meth)acrylates, especially methyl methacrylate, glycidyl methacrylate, n-butyl acrylate, t-butyl acrylate, and/or derivatives, especially anhydrides and imides of unsaturated carboxylic acids, especially maleic anhydride or N-phenylmaleimide, where the percentages by weight are based on 100% by weight of elastomer modifier.

Preferred monomers E.1.1 are to be selected from at least one of the monomers styrene, α-methylstyrene and methyl methacrylate; preferred monomers E.1.2 are selected from at least one of the monomers acrylonitrile, maleic anhydride, glycidyl methacrylate and methyl methacrylate. Particularly preferred monomers are E.1.1 styrene and E.1.2 acrylonitrile.

Graft substrates E.2 suitable for the graft polymers employable in the elastomer modifiers include, for example, diene rubbers, EPDM rubbers, i.e. those based on ethylene/propylene and optionally diene, and also acrylate, polyurethane, silicone, chloroprene and ethylene/vinyl acetate rubbers. EPDM stands for ethylene-propylene-diene rubber.

Preferred graft substrates E.2 are diene rubbers, in particular based on butadiene, isoprene, etc., or mixtures of diene rubbers or copolymers of diene rubbers or mixtures thereof with further copolymerizable monomers, especially of E.1.1 and E.1.2, with the proviso that the glass transition temperature of component E.2 is <10 °C, preferably <0 °C, particularly preferably <−10 °C.

Lubricants and/or demoulding agents employable as additives preferably include long-chain fatty acids, especially stearic acid or behenic acid, salts thereof, especially calcium stearate or zinc stearate, and the ester derivatives thereof, especially those based on pentaerythritol, especially fatty acid esters of pentaerythritol or amide derivatives, especially ethylenebisstearylamide, montan waxes and low molecular weight polyethylene or polypropylene waxes. Montan waxes in the context of the present invention are mixtures of straight-chain saturated carboxylic acids having chain lengths of 28 to 32 carbon atoms.

### Process

The invention also relates to a process for producing tracking-resistant electromobility components having a colour distance ΔE from the L*a*b* coordinates to a colour number of the RAL colour chart beginning with a “2” of <20 and having a CTI determinable according to IEC 60112 in the range from 425 to 600 volts with a maximum divergence in the CTI of 2.5% relative to a component of the same composition without colourant by mixing at least one polyester and 1,3-dihydro-5,6-bis(((2-hydroxy-1-naphthyl)methylene)amino-2H-benzimidazol-2-onato(2-)—N5,N6,O5,O6)nickel to afford polymer compositions, extruding said mixtures, cooling them until pelletizable, drying and pelletizing them and subsequently further processing the polymer compositions by injection moulding, including the special processes of gas injection techniques (GIT), water injection techniques (WIT) or projectile injection techniques (PIT), in extrusion processes, including in profile extrusion or by blow moulding, wherein
A) per 100 parts by mass of at least one polyester,
B) 0.01 to 3 parts by mass, preferably 0.01 to 2.5 parts by mass, of 1,3-dihydro-5,6-bis(((2-hydroxy-1-naphthyl)methylene)amino-2H-benzimidazol-2-onato(2-)—N5,N6,O5,O6)nickel are employed.

It is preferable when also for the process according to the invention the electromobility components have a colour distance ΔE from the L*a*b* coordinates to a colour number of the RAL colour chart beginning with a “2” of <10, particularly preferably <5.

It is preferable when the polyester employed is polycarbonate or C₂-C₁₀ polyalkylene terephthalate, in particular polybutylene terephthalate.

For the sake of clarity, it is noted that the scope of the present invention encompasses all definitions and parameters recited in general in the context of the electromobility components or recited in ranges of preference in any desired combinations of the processes according to the invention.

### EXAMPLES

To demonstrate the improvements in properties described in accordance with the invention, corresponding polyester-based polymer compositions were first made up by compounding. To this end, the individual components were mixed in a twin-screw extruder (Leistritz LSM 30-34 from Leistritz AG (Nuremberg, Germany)) at temperatures between 270 °C to 300 °C, extruded, cooled until pelletizable and pelletized. After drying (generally for two days at 80 °C in a vacuum drying cabinet), the pellets were processed by injection moulding at temperatures in the range from 270 to 290 °C to give standard test specimens for the respective tests.

In the context of the present invention the measure for tracking resistance of the moulding materials described in table I in the form of 60-40-2 mm³ plates was the CTI value (comparative tracking index) in volts according to IEC 60112.

### Starting Materials:

Component A): polybutylene terephthalate (Pocan® B1505, Lanxess Deutschland GmbH, Cologne, Germany)
Component B): 1,3-dihydro-5,6-bis(((2-hydroxy-1-naphthyl)methylene)amino-2H-benzimidazol-2-onato(2-)—N5,N6,O5,O6)nickel [CAS-No. 42844-93-9], Lanxess Deutschland GmbH, Cologne, Germany)

TABLE I

| | | Ex. 1 | Comp. 1 | Comp. 2 |
|---|---|---|---|---|
| Component A) | Pts. by wt. | 99.9 | 100 | 94 |
| Component B) | Pts. by wt. | 0.1 | | 6 |
| CTI tracking resistance | [V] | 596 | 600 | 225 |

In the results in table I the inventive example 1 shows no adverse impairment of the tracking resistance determined according to IEC 60112 compared to the uncoloured material in comp. 1. The investigated plastic plates in inventive example 1 had an RAL colour value of 2001 with a ΔE of <10.

The tracking resistance of the samples investigated in the context of the present application was then determined in accordance with IEC 60112 “Method for the determination of the proof and the comparative tracking indices of solid insulating materials” using 60 mm⋅60 mm⋅2 mm plates by applying altogether 50 droplets of standardized electrolyte solution dropwise at a time interval of 30 seconds and simultaneously measuring the current between two platinum electrodes on the surface until a tracking current of >0.5 A was achieved.

1. A tracking-resistant electromobility component having a colour distance ΔE from the L*a*b* coordinates to a colour number of the RAL colour chart beginning with a “2” of <20 comprising at least one polyester and 1,3-dihydro-5,6-bis(((2-hydroxy-1-naphthyl)methylene)amino-2H-benzimidazol-2-onato(2-)—N5,N6,O5,O6)nickel, wherein the tracking resistant electromobility component has a CTI determinable according to IEC 60112 in the range from 425 to 600 volts with a maximum divergence in the CTI of 2.5% relative to a component of the same composition without colourant and with the proviso that 0.01 to 3 parts by mass of the 1,3-dihydro-5,6-bis(((2-hydroxy-1-naphthyl)methylene)amino-2H-benzimidazol-2-onato(2-)—N5,N6,O5,O6)nickel are employed per 100 parts by mass of the t east one polyester.

2. The tracking-resistant electromobility component according to claim 1, wherein the at least one polyester is a C₂-C₁₀ polyalkylene terephthalate or polycarbonate.

3. The tracking-resistant electromobility component according to claim 1, wherein 0.01 to 2.5 parts by mass of the 1,3-dihydro-5,6-bis(((2-hydroxy-1-naphthyl)methylene)amino-2H-benzimidazol-2-onato(2-)—N5,N6,O5,O6)nickel are present per 100 parts by mass of the at least one polyester.

4. The tracking-resistant electromobility component according to claim 1, wherein the tracking-resistant electromobility component is either directly in contact with a voltage-conducting part or is directly adjacent thereto, or in spatial proximity thereto, and acts as a touch guard, a warning marking or a shielding means.

5.-13. (canceled)

14. The tracking-resistant electromobility component according to claim 2, wherein the at least one polyester is polybutylene terephthalate.

15. The tracking-resistant electromobility component according to claim 4, wherein the tracking-resistant electromobility component is directly in contact with the voltage-conducting parts.

16. The tracking-resistant electromobility component according to claim 1,
wherein,
in the case of a battery component, said electromobility component is selected from standard and round cell modules, cell housings, cell connectors, cell contacting systems, module connectors, pressure compensating elements, seals and intelligent battery management systems, or,
in the case of a proton-exchange membrane fuel cell, said electromobility component is selected from modules or stack modules, metallic bipolar plates, end and media modules and sealing systems, or,
in the case of an electric drive unit, said electromobility component is selected from seals and function-integrated housing lids, housing seals, shaft sealing rings, disk carriers and stamped stacks, shielding systems and dynamic precision parts.

17. A process for producing a tracking-resistant polyester-based electromobility component having a colour distance ΔE from the L*a*b* coordinates to a colour number of the RAL colour chart beginning with a “2” of <20 comprising
mixing 1,3-dihydro-5,6-bis(((2-hydroxy-1-naphthyl)methylene)amino-2H-benzimidazol-2-onato(2-)—N5,N6,O5,O6)nickel with at least one polyester;
extruding the mixture;
cooling the extruded mixture until pelletizable;
pelletizing; and
injection molding or extruding the pellets into an electromobility component,
wherein tracking resistance of the electromobility component in the form of a CTI determinable according to IEC 60112 is in the range from 425 to 600 volts with a maximum divergence in the CTI of 2.5% relative to a component of the same composition without colourant.

18. The process according to claim 17, wherein the at least one polyester is a C₂-C₁₀ polyalkylene terephthalate or polycarbonate.

19. The process according to claim 18, wherein the at least one polyester is polybutylene terephthalate.

20. The process according to claim 17, wherein 0.01 to 3 parts by mass of the 1,3-dihydro-5,6-bis(((2-hydroxy-1-naphthyl)methylene)amino-2H-benzimidazol-2-onato(2-)—N5,N6,O5,O6)nickel are present per 100 parts by mass of the at least one polyester.

21. The process according to claim 20, wherein 0.01 to 2.5 parts by mass of the 1,3-dihydro-5,6-bis(((2-hydroxy-1-naphthyl)methylene)amino-2H-benzimidazol-2-onato(2-)—N5,N6,O5,O6)nickel are present per 100 parts by mass of the at least one polyester

22. The process according to claim 17, wherein the electromobility component is a component that is either directly in contact with a voltage-conducting part, or directly adjacent to a voltage-conducting part, or in spatial proximity to a voltage-conducting part and acts as a touch guard, a warning marking or a shielding means.

23. The process according to claim 21, wherein the electromobility component is directly in contact with the voltage-conducting parts.
